(19) United States
(12) Patent Application Publication
(10) Pub. No.: US 2011/0231272 A1
(43) Pub. Date: Sep. 22, 2011

(54) Retail mobile point-of-sale (POS) software application and retail middleware software application

(75) Inventors: Karl Englund, Rancho Cucamonga, CA (US); Dennis Carson, Rancho Cucamonga, CA (US)

(73) Assignee: APP MASTERS LLC, Rancho Cucamonga, CA (US)

(21) Appl. No.: 12/928,651

(22) Filed: Dec. 16, 2010

Related U.S. Application Data
(60) Provisional application No. 61/385,093, filed on Sep. 21, 2010.
(60) Provisional application No. 61/314,502, filed on Mar. 16, 2010.

(51) Int. Cl. G06Q 20/00

(52) U.S. Cl. 705/21

(57) ABSTRACT

A portable electronic device includes a memory and processor. The memory stores instructions, which are part of a retail mobile software purchase software application. The instructions, which when executed by the processor cause the portable electronic device to first transmit a search request for an item. The device receives item information including item description and item price and also receives a selection to purchase the item from a purchaser. The retail mobile software creates an order including the selected item and adds other selected items to the order. The retail mobile software application displays payment options for the order and receives a payment option selection for the order including the selected item. The retail mobile software application receives payment confirmation for the order including the selected item and displays receipt options for the order including the selected item. The retail mobile software application receives a selection of a receipt option and generates an electronic receipt for the order.

### RELATED APPLICATIONS

This application claims priority under 35 U.S.C. §119(e) to U.S. Provisional Application Ser. No. 61/314,502 filed Mar. 16, 2010, entitled “Retail Software Application,” and U.S. Provisional Application Ser. No. 61/385,093 filed Sep. 21, 2010 and entitled “Paymaster Middleware Software,” all of which are specifically incorporated by reference herein.

### BACKGROUND OF THE INVENTION

In the past, retailers have had a hard time providing customer service to customers who still shop in physical stores. With online shopping available and easily accessible to most purchasers, retailers desire to make the shopping experience a pleasant and quick experience. During rush times (sales events, evening hours, weekends, holiday seasons, etc.), many purchasers visit the physical retail location.

Retail salespeople and managers have a difficult time assisting all of the customers because during these rush times, the check out lines become very long (requiring that the maximum number of cashiers be staffed) and the inventory stock in the store may become very disorganized. In addition, many customers are looking for sizes that may not be out on display or are looking for help in finding items that were displayed online or in advertisements. The purchasers want to spend as little time as possible waiting in line and do not want to wait in line to purchase items or to speak with a sales person.

In addition, during these rush times theft and inventory control are a problem because the retail store staff cannot monitor all purchasers who enter and exit the store. Because the central nature of checkout (i.e., purchasing items), more staff is concentrated in the checkout area of the store, which may leave the other areas of the retail location with very few staff to answer questions.

Accordingly, there is a need to develop an automated solution that allows retail store staff to be mobile (i.e., move to various locations within the retail store) and complete transactions (e.g., item search, price lookup, item purchase, etc.). Developing an automated solution including a portable electronic device and software would help alleviate the pain felt by both retailers and consumers in the form of lack of personalized customer service, long check out lines, theft & inventory control, product returns, and non-repeat customers. This automated solution should work for retailers who have existing retail purchase software and systems, as well as for retailers who do not have an existing retail purchase software system.

### BRIEF DESCRIPTION OF THE DRAWINGS

FIG. 1 illustrates a computer-implemented process for purchasing a product in a retail embodiment utilizing a portable electronic device running a retail mobile software application according to an embodiment of the invention;

FIG. 2 illustrates a portable electronic device having a scanner and including a retail purchase software application according to an embodiment of the invention;

FIG. 3 illustrates an entire retail purchase system and dataflow between parts of the retail purchase system according to an embodiment of the invention;

FIG. 4 illustrates the device or apparatus housing the retail middleware purchase software application according to an embodiment of the invention; and

FIG. 5 illustrates operation of a translations module translating a request according to an embodiment of the invention.

### DETAILED DESCRIPTION OF THE INVENTION

Now with PayMaster retail mobile POS software application and the PayMaster Middleware software application, App Masters is Leading The Retail Revolution™ by providing mobile POS software to retailers of any size, thus ensuring that customers around the world won't have to wait in long, time-consuming check out lines. They can simply shop freely around the store. With PayMaster mobile POS software application, every salesperson is a mobile cash register, thus ensuring immediate customer satisfaction, while building impulse sales and customer loyalty.

The emphasis of PayMaster mobile POS software application (and retail middleware software application) is to relieve the retailer's pain and to greatly improve the guest's shopping experience by affording the retailer the ability to finally offer superior customer service and convenience at an affordable price, while reducing store overhead. In doing so, the highly customizable App Masters turnkey retail solution (the PayMaster software) is seamlessly and securely integrated and implemented with a client's current POS system. It provides a measurable degree of personal attention to customers, mobile check out with associates from anywhere on the selling floor, no waiting at check out, and improved guest's experience and satisfaction.

The system (the scanner and iPod touch coupled with our PayMaster retail POS software), uses a touch screen interface to access nearly every feature a salesperson would need to help a guest, including purchases with credit, gift and debit cards, cash, and making returns. It combines iPod Touch features with a magnetic stripe reader, advanced barcode scanner and software to speed plastic and cash transactions. This functionality and features may easily be transferred to other portable electronic devices, such as the iPad, or smartphones.

For credit card and instant credit transactions, guests or purchasers, write their signature on the device using finger entry and control. Any employee who has the portable electronic device can accept cash transactions. After entering all the products and totaling the cost, the employee presses an on-screen “Cash” button to electronically open one of any number of cash drawers installed around the store. Guests (or purchasers) will continue to have the option to receive a printed or e-mailed receipt, or both.

For product returns, the original purchase can be located by scanning the barcode of the purchase receipt. Without a receipt, the portable electronic device running the Paymaster Mobile POS software can search for the purchase by the guest's e-mail address, product serial number, or the credit/debit card number. The portable electronic device captures why the return is being made, and will then generate a credit to the guest's account, along with a printed or e-mailed receipt.

Regardless of the retailer's size, every sales associate provides one-on-one personal service from sale to check out. Smaller retailers without in-house POS systems may use the entire PayMaster POS Solution (i.e., retail mobile POS software application, retail middleware software application and POS system, hosted on our secure servers in the U.S.A. and linked to existing cash drawers and printers via secure wireless connections). Although the existing customer retail system is referred to as a POS system, many retailers divided out functionality of the POS system and call different parts of the POS system, the customer relations management (CRM) system, the POS system, the inventory system, the database system.

And for enterprise level retailers, all transactions can be linked to the retailer's existing POS system using our connectivity solution (i.e., the Paymaster Middleware software application) that allows effortless connectivity to virtually any legacy POS system with minimal impact on internal IT resources and without complex training or expensive technology.

The PayMaster software application also affords the customer the ability to apply for instant credit right on the device by simply answering a handful of basic questions. Thus eliminating having to wait in a separate line to fill out a lengthy paper application and answer potentially embarrassing questions to a new face. Because a credit decision appears on the portable electronic device screen running the PayMaster software application in only minutes, this functionality greatly reduces the possibility of the customer suffering from “buyer's remorse” or time to change his mind.

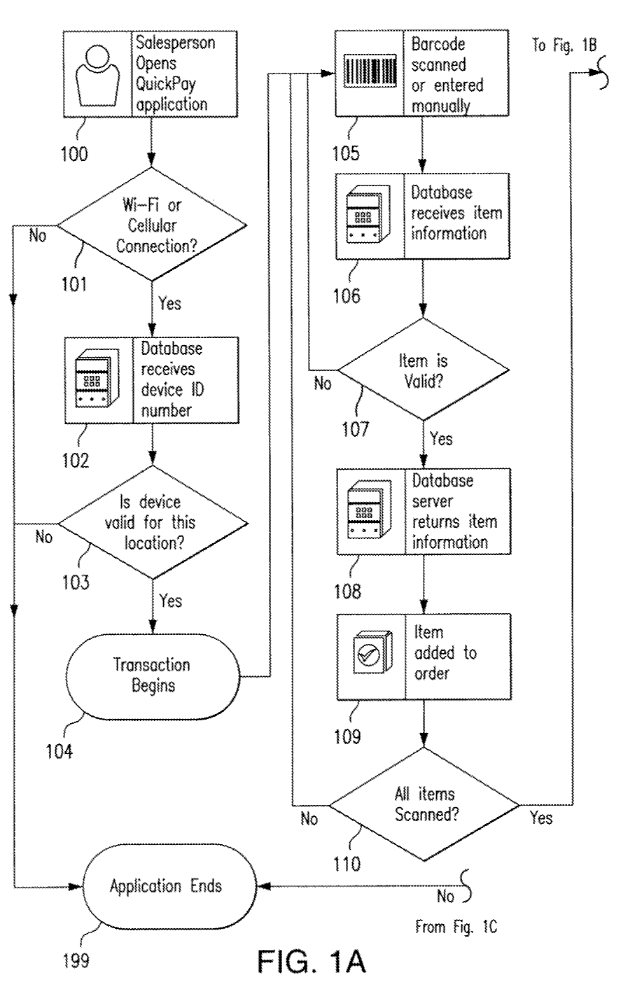

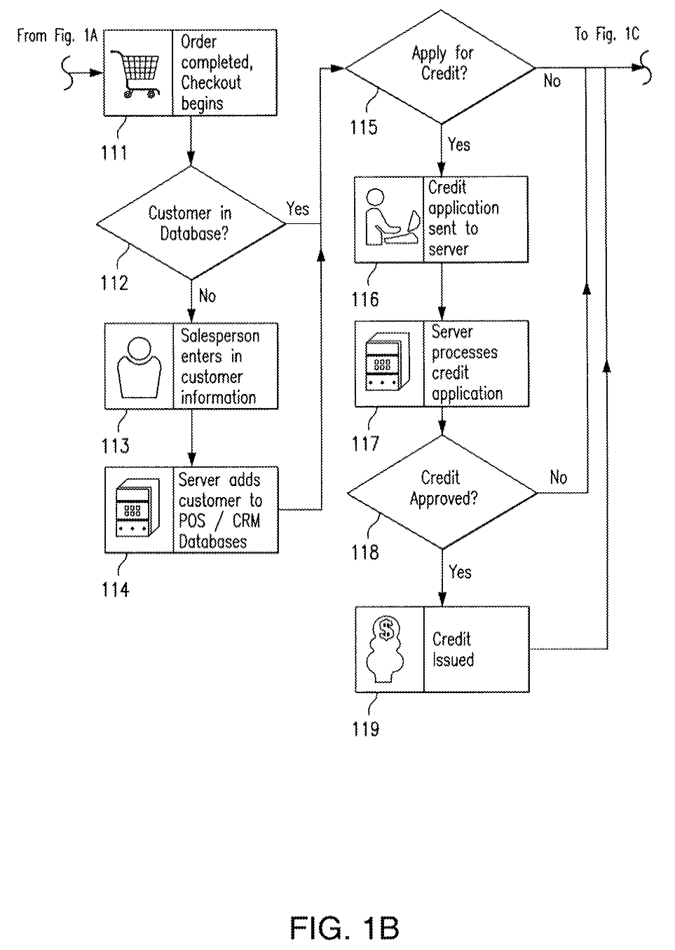

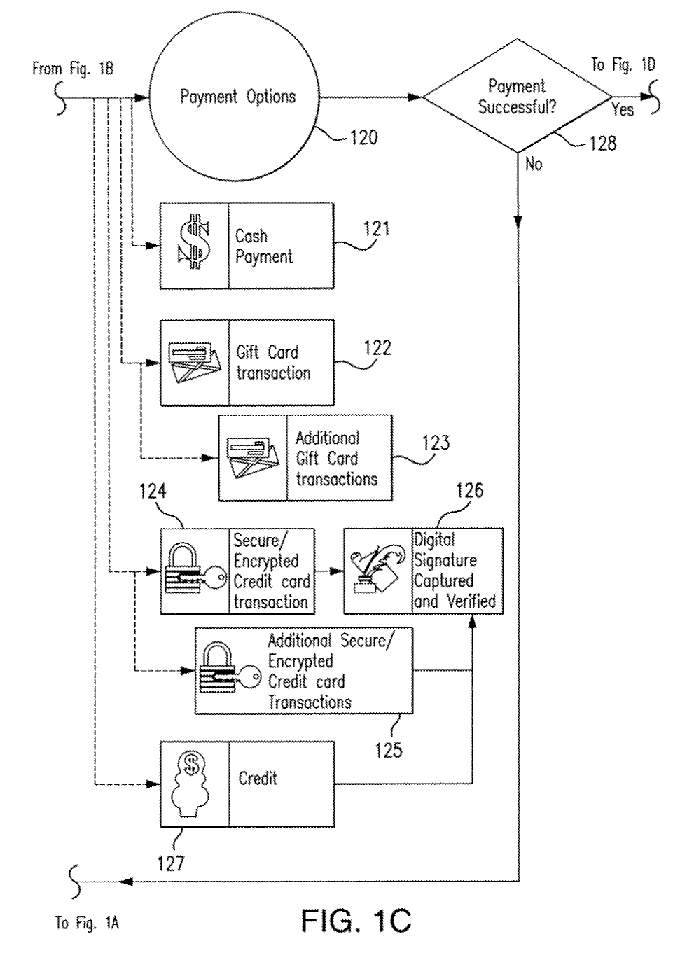

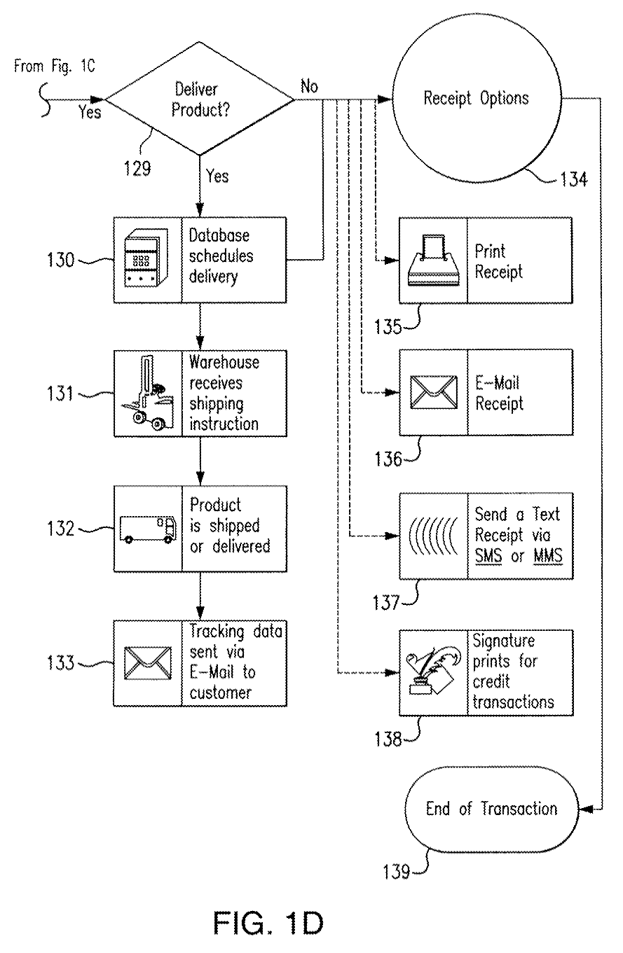

FIG. 1 illustrates a computer-implemented process for purchasing a product in a retail embodiment utilizing a portable electronic device running a retail mobile software application according to an embodiment of the invention. Illustratively, the retail mobile software application may be the PayMaster mobile POS software application.

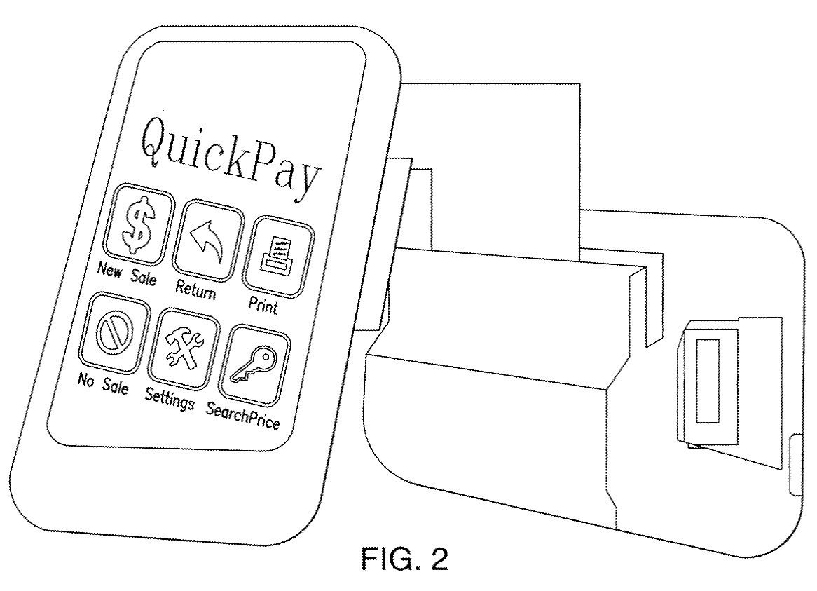

A salesperson in a retail environment has a portable electronic device including scanning capabilities and functionality. FIG. 2 illustrates a portable electronic device having a scanner and including a retail purchase software application according to an embodiment of the invention. The portable electronic device includes memory, a processor, non-volatile memory (such as a hard disk, a USB drive or a memory card), an input/output device that includes a barcode scanner, magnetic stripe reader, and a battery, a display, a payment-receiving device, and the retail mobile purchase software. The retail mobile software including instructions are stored in the non-volatile memory and are executed by the processor to cause the portable electronic device to perform the computer-implemented method. The retail mobile software application may be referred to hereinafter by a number of names, including Paymaster mobile software application, the retail mobile purchase software application and the Paymaster Mobile POS software application.

The portable electronic device communicates with a retail purchase server, which can be resident in the retail location, or that may physically reside in a remote location. In an embodiment of the invention, the retail location may have an existing server, with which the retail mobile purchase software application may communicate directly. If the retail location does not have a server, the retail mobile purchase software application may connect with the remote retail purchase server.

In an embodiment of the invention, if the retailer does not have an existing POS system, the retailer may install a retail purchase server. The retail purchase server may run software applications that perform a number of functions. The retail purchase server may include point-of sale (POS) server functionality and software, customer relationship management server (CRM) functionality and software, and an email server. The retail purchase server may also include a POS database for storing point-of-sale information and a CRM database for storing customer relationship management (CRM) information. Further, the retail purchase server may include a product database for storing item description and pricing information. The retail purchase server may include an inventory database to identify the inventory remaining of each item. In an embodiment of the invention, the retail purchase server may also be referred to as an existing customer software application or an existing customer server. Even if the term server is utilized, this still refers to the software applications running on the identified server. In the retail industry, there are many naming conventions for the retail purchase server, such as described above, and retailers may have many different names. Thus, the use of retail purchase server should not be limiting in that the retail purchase server may include functionality such as POS functionality, CRM functionality, inventory functionality, database functionality and email functionality.

A salesperson with a portable electronic device opens 100 retail mobile purchase software application. The retail mobile purchase software application communicates 101 with the retail purchase server via Wi-Fi if Wi-Fi is available. If Wi-Fi is not available in the location, the retail mobile purchase software may communicate with the retail purchase server via the cellular phone network. If neither Wi-Fi nor a cellular data connection is available, the retail mobile purchase software application may transmit 199 an error message to the display of the portable electronic device notifying the user of the communication failure.

Still referring to FIG. 1, in an embodiment of the invention, the retail mobile purchase software on the portable electronic device transmits 102 its unique ID to the retail purchase server. The retail purchase server then verifies 103 that the portable electronic device (and/or the salesperson) is valid for this retail location and has an active status. If the device (and/or the salesperson) is not valid for this location, the retail mobile purchase software sends an error message, which is displayed on the portable electronic device and the retail mobile purchase software application ends 199.

The retail mobile purchase software application receives input identifying that a transaction is to begin 104. A salesperson utilizes the portable electronic device to scan 105 an item barcode and the retail mobile purchase software application receives the scanned item information. The retail mobile software application transmits 106 the scanned item information to the retail purchase server, which receives 106 the scanned item information. The retail purchase server determines 107 if the item is a valid item and if the item is not valid, the retail purchase server transmits a message to the retail mobile software application that the item is not valid, and the retail purchase server returns the user/salesperson to step 105. If the item is valid, the retail purchase server transmits 108 the product identification information, the retail mobile purchase software application then receives product identification information and adds 109 the item to a potential order. The potential order is created within the retail mobile purchase software application and stored in memory in the portable electronic device. The potential order is not a final order until all of the items have been added to the order and a checkout process has begun. The potential order is not transmitted to the retail purchase server because it is not in final form and may be cancelled, revised or suspended. If potential orders were transmitted to the retail purchase server, the retail purchase server would need to be cleaned of all potential orders at regular intervals.

Alternatively, the retail mobile purchase software application running on the portable electronic device receives 105 product identification information input by the salesperson. The retail mobile purchase software application on the portable electronic device transmits the product identification information to a point of sale (POS) server. The POS server utilizes the product identification and validates 107 the product. If the product is valid, the server retrieves all applicable product information such as item description information, pricing, categories, taxable status, etc. 108. The item description information may include a description of the product, a price of the product, and a classification of the product.

Illustratively, if a potential order has not yet created, i.e., this is the first item, the retail mobile purchase software application creates 109 an order and the item is added to the newly-created potential order. If a potential order already exists in the retail mobile purchase server, then the item and the item description information are added 109 to the existing potential order.

The retail mobile purchase software on the portable electronic device continues to receive product identification information and continues to retrieve item description information and places this in an existing potential order until the retail mobile purchase software on the portable electronic device receives 111 an order completion command. After receiving the order completion command, the retail mobile purchase software may close out the potential order.

The retail mobile purchase application software may also include a customer relationship management module (or customer relationship management software application). The customer relationship management software application also includes, or interfaces with, a customer relationship management database. The customer relationship management database includes customer contact information, birth date information, purchase category information, purchase data information, demographic information, and address information. Retail stores utilize a customer relationship management database to track customers in order to target customers for specific offers and reward programs. In an embodiment of the invention, a customer record in the customer relationship management database may include a photo image of the customer.

After the retail mobile purchase software application in the portable electronic device receives the order completion command, the retail mobile purchase application software checks 112 to see if the customer who is making the purchases is in the CRM database. The retail mobile purchase software application communicates with the CRM database in the retail purchase server to determine if the customer is within the database. If the customer is not in the CRM database, the retail mobile purchase software application in the portable electronic device receives 113 customer information input and this customer information input is transmitted to the retail purchase server and added 114 to the CRM and POS databases. In an embodiment of the invention, a salesperson or cashier may take a picture of the customer, store the image temporarily on the portable electronic device and transfer the customer image to the CRM database utilizing the retail mobile purchase software application.

The retail mobile purchase software may include a checkout module. The checkout module may include a credit request module, a payment module, an update records module, and a receipt module. Each of these modules may also be referred to as software applications, plug-in software, etc.

In an embodiment of the invention, a salesperson may suspend a transaction. A transaction may be suspended because the purchaser has decided to continue shopping and looking for additional items, the purchaser had to leave the retail store but plans on coming back, a new salesperson is taking over the transaction or for a number of different reasons. If a transaction is to be suspended, the retail mobile purchase software application may receive a suspend notification. Illustratively, there may be a menu option where a salesperson selects a suspend icon or the portable electronic device may have a button that is depressed to indicate that a transaction should be suspended. Once the suspend notification is received, the retail mobile purchase software saves all of the purchaser and transaction information that has been entered. Illustratively, if two items have been scanned and item information has been received, the item information for the two scanned items is saved. If information regarding the purchaser has been received, the retail mobile purchase software saves the purchaser information. The saved information may be referred to as the suspended transaction information. In an embodiment of the invention, the suspended transaction information is stored in a memory at the portable electronic device by the retail mobile purchase software. In an embodiment of the invention, the suspended transaction information is transmitted, by the retail mobile purchase software application, to the retail purchase server for storage into a memory. When a salesperson wants to activate the suspended transaction, the salesperson may select an icon or depress a button. The retail mobile purchase software application may receive the activation instructions and may retrieve the suspended transaction information. The suspended transaction information is retrieved from the portable electronic device or the retail purchase server and the transaction is resumed at the point at which the transaction was suspended.

In an embodiment of the invention, if a purchaser is looking to obtain credit from the retailer, the retail mobile purchase software may activate or open 115 a credit request module. For example, the portable electronic device may display a menu including a request credit option (which may be selected via a button or menu selection). The credit request software application may receive customer identification information from the purchaser. Illustratively, the customer identification information may include a social security number, a government identification number, purchaser date of birth, purchaser address, etc. The customer identification information may also include the purchasers' next of kin, and drivers' license number. After the credit request module receives the customer identification information, the input customer identification information is transmitted 116 by the retail purchase mobile software to a credit facility. This transmission of the customer identification information is secure and encrypted. Under certain operating conditions, the customer identification information is transmitted to the retail purchase server wirelessly. The server then uses a secured wired connection to transmit the customer identification information between the retail purchase server and the credit facility 117. The credit facility determines 118 whether or not the customer receives approval and also provides a credit amount for the purchaser. The approval (and the credit amount) is transmitted to the retail purchase server and to the retail mobile purchase software application on the portable electronic device. In an embodiment of the invention, the retail mobile purchase software may interact directly with the credit facility.

The credit request module of the retail mobile purchase software application receives 119 the credit approval (and credit amount) or the credit denial 119. After the portable electronic device and the credit request module have received the credit approval or denial, the retail mobile purchase software application closes the credit request module. Illustratively, the credit request screen may be closed on the display of the portable electronic device and the retail purchase main menu may appear on the display of the portable electronic device. The credit request, approval, denial process takes only a few minutes and is performed utilizing the retail mobile purchase software application on the portable electronic device, without the purchaser (or credit applicant) having to fill in, sign and submit a form. This is a significant improvement on the current credit application process within a retail store. The credit facility may be an external credit facility (such as Experian, Transunion, Equifax) or could be an internal credit facility (such as GE Credit Corporation), or a retail store's own credit facility (such as a Macy's credit facility or a Bloomingdale's credit facility).

The retail mobile purchase application software may receive payment-processing input identifying that payment for the order is to begin or proceed. The retail mobile purchase software opens 120 a payment module (or payment software application). Illustratively, a user of the portable electronic device (e.g., a salesperson) may select a payment icon on the display and an order payment menu may be displayed. For example, the order payment menu may be a tender screen that includes an initial amount, additional fees charged, discounts received, a subtotal, taxes and a total amount.

An advantage and unique aspect of the payment module is that the payment module can accept multiple credit cards as payment for the order using the retail mobile purchase application software installed on the portable electronic device. A further advantage and unique aspect of the payment module is that the payment module can accept debit cards, credit cards, store gift cards and cash as payment for one order. In other words, it can accept any combination of the debit cards, gift cards, or credit cards as payment for a single transaction. Illustratively, the payment menu may include a cash payment icon, a gift card icon and a credit card icon.

The payment module with the retail mobile purchase software application may receive a cash payment selection indicating that the purchaser is paying cash for at least a part of the order 121. After receiving the cash payment selection, the payment module may receive cash payment information (e.g., an amount in dollars and cents). The payment module of the retail mobile purchase software application determines if the cash payment information is enough to satisfy the order payment amount. If the payment amount is determined to be enough, the payment is complete and retail mobile purchase software application closes the payment module. Illustratively, a cash payment screen may be displayed and the salesperson may input the cash amount into the payment module of the retail mobile purchase software application.

The payment module of the retail mobile purchase software may receive a credit card selection indicating that the purchaser may be using a credit card or debit card to pay for all of the order amount or at least part of the order amount 124. Illustratively, the credit card or debit card icon may be selected from the payment main menu. After receiving the credit/debit card selection, the salesperson may swipe the credit card through a payment-receiving device on the portable electronic device and the reader may transmit 124 the encrypted scanned credit card information via a secured connection to the payment module of the retail mobile purchase software application. In an embodiment of the invention, the payment module may receive the authorization code after it is manually entered into by the salesperson. The salesperson can also enter the payment amount and the payment module may receive this amount. Alternatively, a salesperson may manually enter the credit card number, the verification code and the payment amount and all of this information is transmitted to the payment module. In an embodiment of the invention, the payment module of the retail mobile purchase software application then transmits this information (number, code, and amount) to a third-party credit verifier and the third-party credit verifier transmits either a credit approval or a credit denial back to the payment module in the portable electronic device. In an alternative embodiment of the invention, the payment module of the retail mobile purchase software application may transmit the credit information to the retail purchase server and the retail purchase server may transmit the credit information to the third-party credit verifier. After the third party verifier transmits the authorization and the payment module of the retail mobile purchase software application receives the authorization (either directly or indirectly through the retail purchase server), the payment module subtracts the payment amount charged to the credit card from the order amount. If the credit card amount is enough to satisfy the order amount, the payment module is complete and the retail purchase application software closes the payment module.

A purchaser may also utilize either an additional credit card, (e.g. a second credit card, or a second credit card plus a third credit card) to make 125 payment amounts for the completed order. This allows the purchaser to spread the purchase among a number of different credit cards. The process described above for the first credit card is also utilized for the second, third or subsequent credit cards. This is a significant advantage over existing systems that allow only one credit card to be utilized for a transaction involving a portable electronic device in a retail environment. After the authorization is received from the last third party credit verifier, and payment for the completed order has been completed, the retail purchase application software closes the payment module. Illustratively, the payment menu may be closed on the portable electronic device and the retail purchase menu may appear on the screen of the display module.

Gift cards are processed in a similar fashion as credit cards are processed, the payment amount is transmitted to the bank or store issuing the gift card, and an authorization amount is received back. The retail mobile purchase software application will deduct the authorized amount from the total due. The payment module may receive a gift card selection indicating that the purchaser may be utilizing a gift card to pay for all of the order or at least part of the order. Illustratively, a gift card icon may be selected from the payment main menu. The gift card may be a store gift card or another general-purpose gift card. After receiving the gift card selection, the salesperson may swipe the gift card through the payment-receiving device on the portable electronic device. The payment-receiving device may be a magnetic reader or barcode scanner. The payment-receiving device may transmit 122/123 the gift card information and potentially an authorization code to the payment module. Alternatively, a salesperson may manually enter the gift card number and the authorization code and the payment module may receive the gift card number and potentially an authorization code. The payment module may transmit the gift card number and the authorization code to a third party verifier to verify that the gift card is authentic. For example, Authorize.net and/or PayPal may be a third party verifier of gift cards. The payment module may receive an authorization back from the third party verifier. After the third party verifier receives the authorization, the payment module subtracts the gift card amount from the order amount. If the gift card amount is enough to satisfy the order amount, the payment module is complete and the retail purchase application closes the payment module. In an embodiment of the invention, the payment module of the retail mobile purchase software application transmits the gift card number and the authorization code to the retail purchase server, which in turn transmits the information to the third party verifier.

A purchaser may also utilize all or a portion of any credit which was applied for 116 in the credit module and granted 119 as payment for the completed order.

After the total amount of purchase is tendered 128 and received by the payment module of the retail mobile purchase software application, the retail mobile purchase software application may generate and present a list of delivery options. The customer may choose a delivery option if appropriate and a shipping module of the retail mobile purchase software application may receive the selected delivery option 129. If the product needs to be shipped to the purchaser, the shipping module generates a shipping request that is sent to an inventory database. The shipping module of the retail mobile purchase software application transmits the shipping request to retail purchase server and specifically to the inventory database. The inventory database receives the shipping request and generates a shipping schedule 130 for the purchased products. A warehouse system receives the shipping schedule 131 and generates shipping and delivery instructions to meet the delivery guidelines.

The product is then shipped or delivered 132, and delivery information is transmitted back to the POS database in the retail purchase server. The purchased products are then shipped from the warehouse to the purchaser. The delivery provider generates 133 tracking data for the shipment of the purchased products and sends the tracking data via email to the purchaser's email address. The delivery provider provides the tracking data via email until the purchased product is delivered. In an embodiment of the invention, the tracking and delivery information is sent to the retail purchase server, which stores the customer email address, and the retail purchase server transmits the tracking and delivery information to the purchases at the stored email address.

The retail mobile purchase software may also include a receipt module or receipt software application. Illustratively, a salesperson may select a checkout/receipt icon on the display of the portable electronic device and the retail mobile purchase software application may initiate a receipt module. The receipt module may receive 134 receipt information. The receipt information may indicate that the purchaser requests 135 a printed receipt. If the receipt request corresponds to a printed receipt, the receipt module of the retail mobile purchase software application generates printing instructions including the transaction amount and item description information, and transmits the printing instructions to a printer module of the retail mobile purchase software application, which prints 135 the receipt on the portable electronic device (if the portable electronic device includes a printer). In embodiments of the invention, the printer module of retail mobile purchase software application may also print the receipt to printers located within the retail location. The print module includes functionality to add printers from the retail location to interface with the retail mobile purchase software application.

The salesperson may separately, or also, select an email icon from a receipt menu 136. If the received receipt information indicates that the purchaser requests an emailed receipt, the receipt module of the retail mobile purchase software application requests a purchaser's email address 136. The receipt module receives the purchaser's email address and the receipt module of the retail mobile purchase software application generates email instructions including the transaction and the item description information and transmits this information to an email server. The salesperson may separately, or also, select a text or a text icon from a receipt menu 137. If the receipt information indicates that the purchaser requests a text message receipt, the receipt module of the retail mobile purchase software application requests a purchaser's phone number 137. The receipt module receives the purchaser's phone number and generates a text message including the payment amount, the item description and additional information. The receipt module of the retail mobile purchase software application transmits this text message via a cellular phone message to the purchaser's phone.

In an embodiment of the invention, the checkout/receipt module of the retail mobile purchase software application may also receive a photo image of the purchaser and/or a digitally captured signature 138 from the purchaser. Illustratively, the salesperson may utilize a camera in the portable electronic device to take a picture of the purchaser. The camera application generates the photo image and stores the photo image in a memory of the portable electronic device. In an embodiment of the invention, the memory may be a temporary memory of the portable electronic device and not a permanent memory of the portable electronic device. If a photo receipt option is selected, via a photo image icon for example, the checkout/receipt module of the retail mobile purchase software retrieves a copy of the photo image and sends the photo image along with the transaction amount and item description information to the printer module, the email server or to the purchaser's cellular phone.

After a receipt format has been selected, the retail mobile purchase software application closes the receipt module 139. The retail mobile purchase software application is closed 139.

In many cases, a retailer already has an existing retail purchase server or existing retail server. The existing retail purchase server has been established and any customization of this legacy system may be cost prohibitive. The existing retail purchase server has a specified format with which it receives data and existing connections have been established, along with specific communication protocols. In this embodiment of the invention, the retail mobile purchaser software may interface with a retail middleware software application in order to format the data to be seamlessly received by the existing retail purchase server. Paymaster retail middleware software is one such retail middleware software that interfaces with existing retail purchase servers.

Accordingly, in an embodiment of the invention, Paymaster retail purchase software may be implemented utilizing a Paymaster middleware software application. Thus, the functionality of the Paymaster retail mobile purchase software application is the same regardless of the customers' existing Point of Sale system, or even if the customers do not have an existing POS system (or existing sales reporting system). In other words, the same Paymaster retail mobile purchase application software is installed on all portable electronic devices regardless of the existing customer and the existing customers retail purchase server (or POS system).

Generally, for retail purchase systems, the retail middleware software application includes software or software/hardware to interface between the Retail mobile purchase software applications and existing retail purchase systems (e.g., retail purchase servers or retail POS systems). In other words, the retail middleware software application transmits (and receives) data and commands between the retail mobile purchase software (which may reside on a multitude of portable electronic devices, desktop computers. laptops, tablet style computers, and smart phone devices), and the existing retail purchaser servers (or other legacy systems).

The retail middleware software application is a combination of independent software modules and functionality. In an embodiment of the invention, the retail middleware software application may be loaded on a single computing device. In other embodiments of the invention, different modules of the retail middleware software application may be located on different computing devices.

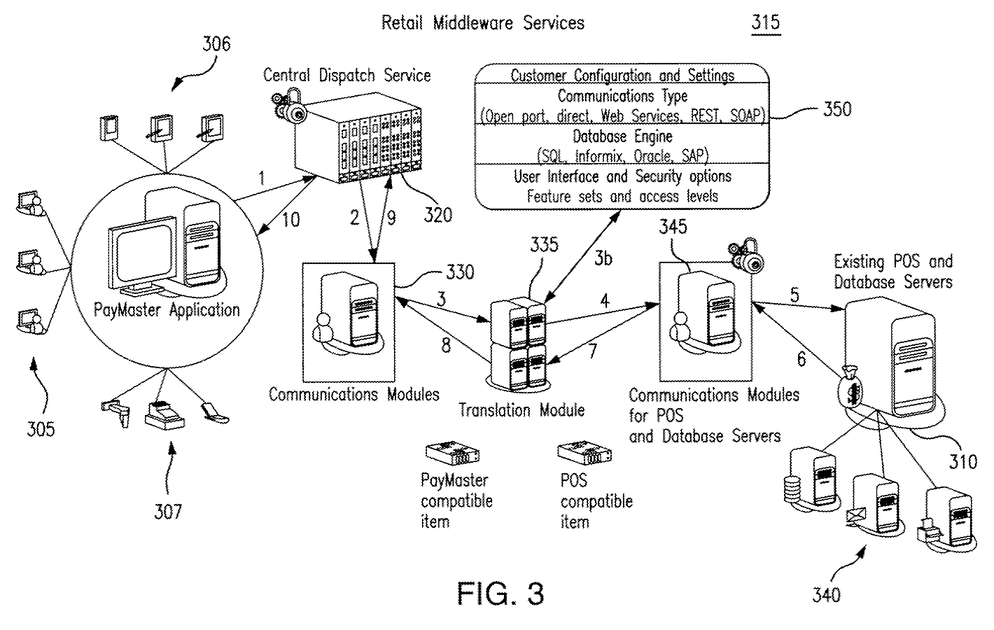

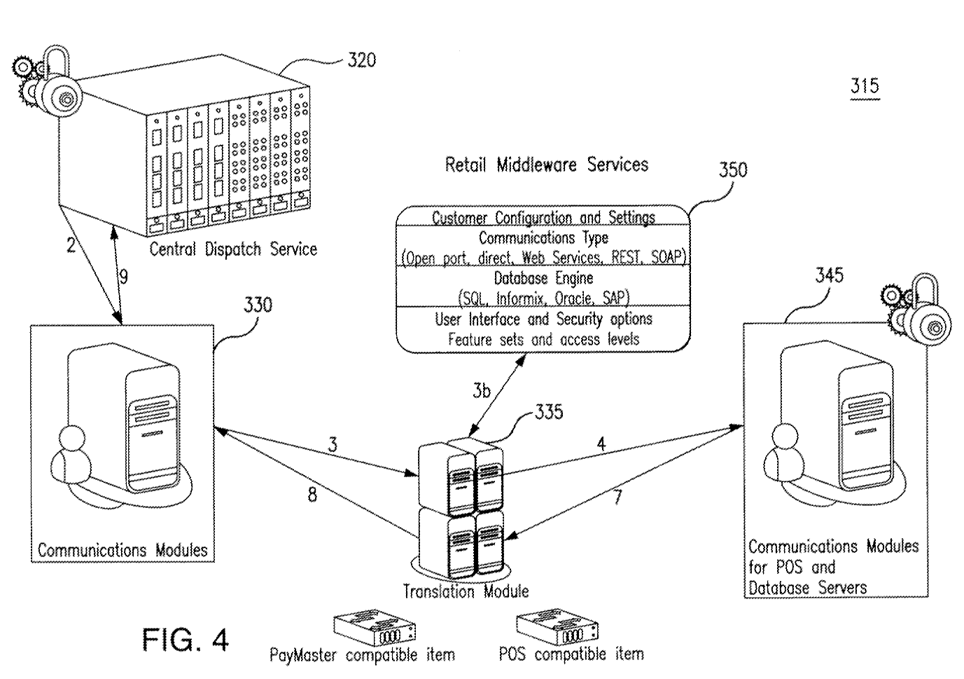

FIG. 3 illustrates an entire retail purchase system and dataflow between parts of the retail purchase system according to an embodiment of the invention. FIG. 4 illustrates the device or apparatus housing the retail middleware purchase software application according to an embodiment of the invention. The entire retail purchase system 300 includes portable electronic devices running the retail mobile purchase software application 305, 306 and 307, a system including the retail middleware purchase software application 315, and the existing retail purchase server 310, which includes the existing retail purchase software application and a database 340. The terms existing retail purchase software application and retail purchase server are used interchangeably within this application.

The retail middleware software application 315 includes a central dispatch software application 320, a communications module 330, a translations module 335, a connection module 345, and a configurations module 350. Each of these modules are software applications that are part of the retail middleware software applications and that run on a computing device, such as a personal computer or server. The connections module 345 connects the retail middleware software application to the existing retail purchase software application and/or the database 340. In an embodiment of the invention, the communications module 330, the translations module 335, the connection module 345 and the configuration module 350 may reside on one physical computing device. In alternative embodiments, these modules may reside on multiple physical computing devices.

The communications module 330 may receive requests from the retail mobile purchase software application running on any of the portable electronic devices 305, 306 307 through the central dispatch software application 320 and may also transmit back the response (from the existing retail purchase server) to the retail mobile purchase software application on the requesting portable electronic device through the central dispatch software application 320.

The translations module 335 of the retail middleware software application may receive data in one format (e.g., a Paymaster defined format or other retail mobile purchase defined format) and convert the data into a format understandable to the existing retail purchase server 310. In other words, in a legacy retail purchase server-compatible format.

The connection module 345 of the retail middleware software application opens and establishes a channel of communications between the existing retail purchase server 310 (and/or database 340) and the different modules of the retail middleware application software 315.

The configuration module 350 of the retail middleware software application stores and controls feature sets and security options for different retail purchase servers and/or different portable electronic devices running the purchase mobile software application. The configuration module 350 may include a number of settings and configurations for different retail purchase server systems 310. In an alternative embodiment, the configuration module 350 may include settings and configurations for only one retail purchase server system 310. The configuration module 350 receives information regarding the retail purchase server system 310 and the retail middleware software application 315, as well as the communications that occur between the retail mobile purchase software applications running on portable electronic devices and the retail middleware software application.

FIG. 3 also illustrates a data flow diagram of a transaction utilizing the retail middleware software application according to an embodiment of the invention. The boxed reference numbers identifies different operations or steps of the transaction.

The retail mobile purchase software application running on one of the portable electronic devices 305 306 307 makes a POS transaction request, (Ref. No. 1), and the transaction request is transmitted to the retail middleware software application 315. Illustratively, the transaction request may be an item search to identify if an item is available in a merchant's inventory. The central dispatch module 320 of the retail middleware software application may receive the transaction request and route the transaction request to the communications module 330 (Ref. No. 2). The communications module 330 may accesses configuration settings for an existing retail purchase server in the configuration module 350 (Ref. No. 3 and 3B). The communications module 330 transmits the configuration settings to the translation module 335. The translation module 335 determines how to properly format the transaction request for the existing retail purchase server system, and how to communicate the formatted transaction request to the existing retail purchase server. The configuration settings may be stored in the retail middleware software application and may be modified or retrieved via the configuration module 350.

The translation module 335 transfers (Ref. No. 4) the newly formatted request to the connection module 345. The connection module 345 communicates with the customers existing retail server/software 310 (and/or database 340) using a communications method and format supported by the existing retail purchase server and software. The connections module 345 submits or transmits the request to the customer's retail purchase server 310. (Ref. No. 5). The customer's retail purchase server sends back a response to the connections module 345. (Ref. No. 6). Once the connections module 345 receives the response from the existing retail purchase server 310, the response is transferred to the translation module 335. (Ref. No. 7). The translation module 335, (using configuration settings for the portable electronic devices running the retail mobile purchase software, which are retrieved from the settings/configuration module 350), formats the response into the format that the requesting portable electronic device running the retail mobile purchase software application utilizes and sends the formatted response to the communications module 330. (Ref. No. 8). The communications module 330 routes the formatted response back to the central dispatch module 320. (Ref. No. 9). The central dispatch module 320 of the retail middleware software application transmits the response back to the retail mobile purchase software application on the requesting portable electronic device (e.g., device 306). (Ref. No. 10).

In summary, the retail middleware software application allows the retail mobile purchase software to access, and communicate with any existing retail purchase server. The existing retail purchase server and software does not need to be modified and the retail mobile purchase software application does not need a large amount of customization or modification. This unique approach morphs the retail mobile purchase software application to fit the existing retail purchase system, rather than requiring modifications on the existing retail purchase system, thus saving time and money.

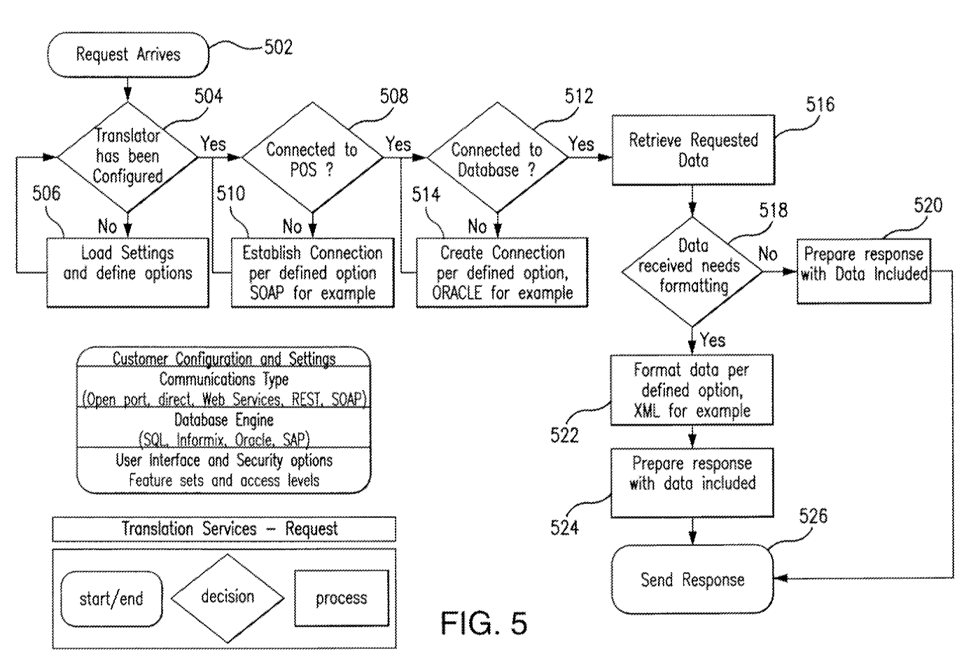

FIG. 5 illustrates operation of a translations module translating a request according to an embodiment of the invention. The translation module 335 may receive 502 a transaction request (e.g., an item lookup transaction). The translations module 335 determines 504 if the translator has been configured, e.g., with the settings of the existing retail purchase server system and/or portable electronic devices running the retail mobile purchase software application. If the translator in the translation module 335 has not been configured, the translation module 335 communicates with the configuration module 350 to retrieve the settings for the existing retail purchase server system and the settings are loaded 506 into the translation module 335. The transaction request is then formatted according to the retrieved settings from the configuration module 350. The translation module 335 determines 508 if the retail middleware software application 315 has connection information for the existing retail purchase server 310. If there is no connection information, the translation module loads or retrieves 510 the connection information. The connection module 345 then determines 512 if the database information for the existing customer database 340 (e.g., structure and query language of database at existing retail purchase sever) has been loaded. If the database information has not been retrieved, the translation module 335 loads or retrieves the database information. The transaction request is formatted according to the retrieved translation, connection and database requirements and transmitted to the connection module 345 of the retail middleware software application. The connection module 345 transmits the formatted transaction request to existing retail purchase server 310 and a response is generated after the retail purchase server queries the appropriate database 340 (CRM, POS, Inventory, Item Lookup). Different customers have different database naming conventions so the retail purchase server may query any databases corresponding or coupled to the retail purchase server. The existing retail purchase server retrieves 516 the requested data corresponding to the transaction request. The existing POS system transmits the retrieved data back to the connections module 345 of the retail middleware software application 310, which transfers the retrieved data to the translation module 335. The translation module 335 of the retail middleware software application determines 518 if retrieved data needs to be formatted in order to be sent to the retail mobile purchase software application running on the requesting portable electronic device. If the retrieved data does not need to be formatted, then the translation module 518 transmits 520 the retrieved data to the retail mobile purchase software application of requesting device utilizing the central dispatch module.

If the translation module 335 of the retail middleware software application determines that the retrieved data needs formatting, then the translation module 335 retrieves the configuration settings for the requesting portable electronics device and formats 522 the retrieved data according to the retrieved settings. For example, the requesting portable electronic device may want the retrieved data formatted according to the XML protocol. The translation module generates 522 a formatted response including the formatted retrieved data. The translation module sends 524 the formatted response to the central dispatch module, which in turn transmits 526 the formatted response to the retail mobile purchase software application running on the requesting portable electronic device.

An illustrative example of the translation process performed by the translation module 335 starts with the retail middleware software application 315 receiving a request for an item lookup for WIDGET1. This may be the first request that the translations module 335 has received. The translation module 335 reads or retrieves configuration settings for the existing retail purchase server system from the database 340 via the settings module 350. Illustratively, these settings may identify that the communications method (in this example, http, with an IP address and port number 192.168.1.120:8080), the database engine utilized by the existing customer POS system (e.g., MySQL), and the security level required to access the existing customer POS system (e.g., 5—Manager). Illustratively, the settings may be stored in the middleware software application 315 (or the database 340 of the existing customer purchase server 310) and may be accessed via the configuration module 350. Under certain operating conditions, the retail middleware software application 315 may have default configuration settings stored in the database.

The translation module 335 utilizes the item identifier (e.g., WIDGET1) passed in the transaction request and creates a text string that contains a MySQL SQL statement to query the database on the existing retail purchase server. Illustratively, the text string may have the format of “Select ITEMNO, ITEMDESC, ITEMQTY, ITEMPRICE FROM ITEMS WHERE ITEM=‘WLDGET1’” This statement (text string) is sent, now as a properly formatted SQL request, to a POS database 340 in the existing retail purchase server, which then retrieves the data.

Illustratively, the POS database 340 in the existing retail purchase server 310 then returns the retrieved information corresponding to the transaction request. Illustratively, the POS database may return a text string such as “‘WIDGET1’, ‘My Widget in Red’, 20, 12.99.” The retrieved information is transmitted to the translation module 335, which formats the response according to the format of the requesting portable electronic device running the retail mobile purchase software application, e.g., XML. Illustratively, the formatted response for the portable electronic device may be:

<?xml version = “1.0”?>
<ItemResponse>
<Item>

<Number>WIDGET1</Number>
<Description>My Widget in Red</Description>
<Available>20</Available>
<Price>12.99</Price>

</Item>
</ItemResponse>

The configuration module 350 may store configuration information and controls access to the different operating parameters or configurations of the retail middleware software application. In an embodiment of the invention, during installation, and/or customization of the retail middleware software application, the settings module 350 receives input regarding the communication protocols, the database architecture and query language, and different user profiles for the existing retail purchase server system and also for the portable electronic devices running the retail mobile purchase software application. Examples of different settings are provided below. In an embodiment of the invention, the retail middleware software application may also automatically determine setting or configuration information for either the existing retail purchase server system or the portable electronic devices running the retail mobile purchase software application.

The following list represents potential communications protocols utilized between the retail middleware software application and the existing retail purchase servers. These communication protocols may also be used between the portable electronic devices running the retail mobile purchase software application and the retail middleware software application. Communications protocols include: (1) HTTPS—Internet Web Server; (2) HTTPS—Local Server/Port (Fixed or Range; (3) POS Web Service API; (4) SOAP; and/or (5) REST

The following list represents potential database engines utilized by existing retail purchase server systems, each of which has a different set of methods for access, queries, and retrieval that require specific languages in order to make successful queries. Database Engines include: (1) Microsoft SQL Server; (2) SAP; (3) Oracle; (4) Informix; (5) MySQL; (6) PostGres; (7) XML; and (8) DBASE

The following is a list of security options that may be set for specific users of the retail mobile purchase software application or the retail middleware software application. Illustratively, each user may have access to different combinations of these items or functions. For example, a junior cashier may be able to search for items, but may not be able to add or edit an item. A mid-level associate may be able to edit items but not add new items. A manager may be able to add a new item and change it's details. Security enabled options include: (1) Add Customer; (2) Edit Customer; (3) Add Item; (4) Edit Item; (5) Search Item; (6) Assign Discount Level 1; (7) Assign Discount All; (8) Edit Price; (9) Manager; and (10) Process Refund

A sales transaction may utilizes the communication channel between a portable electronic device running the retail mobile purchase software application, the retail middleware software application and an existing retail purchase system multiple times before the sales transaction is complete. An illustrative sales transaction may operate in the following manner.

1. Salesperson logs in to the retail mobile purchase software application (the retail mobile purchase software application receives login information) and retail middleware software application is used to verify salesperson's credentials by communicating the login information to the existing retail purchase server.
2. Salesperson specifies the salesperson for the transaction at the retail mobile purchase software application, for commission/sales tracking). The retail mobile purchase software application receives the salesperson identification information, transmits the salesperson identification information to the retail middleware software application, and the retail middleware software application properly formats the salesperson identification information so that this identification information may be used to verify credentials with the existing retail purchase server.
3. Salesperson requests list of receipt printers, retail mobile purchase software application receives list of receipt printers and transmits request to retail middleware software application. Retail middleware software application transmits list of receipt printers to retail mobile purchase software application and customer selects closest receipt printer (in case receipt was requested).
4. Salesperson selects New Sale from the retail mobile purchase software application menu and retail mobile purchase software application receives input from salesperson.
5. Salesperson searches for existing customer utilizing a phone number, retail mobile purchase software application receives customer search request and transmits search request to retail middleware software application. Retail middleware software application formats search request, transmits formatted search request to POS/CRM databases in existing retail purchase server, and receives list of customers or single customer matching search request. Retail middleware software application formats responses and transmits matching customer responses to retail mobile purchase software application.
6. Salesperson scans first item using the barcode scanner at portable electronic device running retail mobile purchase software application, retail mobile purchase software application receives scanned information, and transmits scanned information to retail middleware software application. Retail middleware software application formats the scanned information and communicates with POS database in existing retail purchase server system to verify item.
7. Salesperson scans second item and retail middleware software application is used to verify item as done in Step 6.
8. Salesperson selects the second item at portable electronic device running retail mobile purchase software application, receives input and transmits item selection to retail middleware software application. Retail middleware software application formats item selection and communicates with POS software application in existing retail purchase server to obtain list of available discount types/amounts for selected items. Retail middleware software application receives list of available discount types/amounts for selected items, formats response including list of available discount types/amounts and transmits response to retail mobile purchase software application. Salesperson selects one discount from list and assigns a discount of 50% (Buy 1 get 1 at 50% off sale).
9. Salesperson presses tender button and retail mobile purchase software application receives input. The retail mobile purchase software application presents the tender screen.
10. Salesperson reviews tender screen to make sure that the items, amounts, discounts, and totals are correct.
11. Retail mobile purchase software application prompts salesperson to ask customer for payment.
12. Salesperson swipes customers' credit card using the magnetic strip reader and retail mobile purchase software application receives customer payment information.
13. Retail mobile purchase software application encrypts payment information and transmits encrypted information to Retail middleware software application. The retail middleware software application formats the encrypted payment information and transmits the formatted encrypted payment information to the existing retail purchase server.
14. Authorization is received at the existing retail purchase server, authorization is transmitted to the retail middleware software application, the retail middleware software application formats the authorization and transmits the formatted authorization to the retail mobile purchase software application. Salesperson is notified after retail middleware software application returns result and optional message.
15. Salesperson presents the POS device to the customer for signature using the touch screen.
16. Salesperson verifies the signature and retail mobile purchase software application digitizes signature.
17. Retail mobile purchase software application transmits complete transaction with digitized signature to retail middleware software application. Retail middleware software application formats complete transaction with digitized signature for each receiving system that receives entire transaction. Retail middleware software application transmits the formatted complete transaction and signature to the appropriate POS and CRM databases in customer retail purchase server.
18. Retail mobile purchase software application prompts salesperson with receipt options and salesperson prompts customer for receipt options such as email, print, etc.
19. Customer requests email, retail mobile purchase software application receives input and transmits email receipt request to Paymaster Middleware software application. Retail middleware software application formats receipt in correct format and transfers formatted receipt to email system.
20. Salesperson confirms receipt printing and receipt printing request is received by retail mobile purchase software application.
21. Electronic Receipt is sent from retail mobile purchase software application and retail middleware software application connects to selected printer and prints a copy of receipt.

A price lookup transaction may utilize the communication channel between the retail mobile purchase software application, the retail middleware software application and an existing retail purchase server multiple times before the price lookup transaction is complete. An illustrative price lookup transaction may operate in the following manner.

1. Salesperson logs in to retail mobile purchase software application (the retail mobile purchase software application receives login information) and retail middleware software application is used to verify salesperson's credentials by communicating the login information to the existing retail purchase server.
2. Retail mobile purchase software application presents initial POS menu, salesperson selects Price Search from the menu and retail mobile purchase software application receives price search request.
3. Retail mobile purchase software application presents price search menu and cashier scans the item barcode with the built in scanner. Retail mobile purchase software application, receives scanned item information and looks within retail mobile purchase software application for price.
4. Item is not found in retail mobile purchase software application, and retail mobile purchase software application transmits scanned item information to retail middleware software application, and retail middleware software application formats scanned item information. Retail middleware software application transfers formatted item information to query inventory database in existing retail purchase server and a result is returned.
5. Retail middleware software application receives results from the existing retail purchase server (e.g., item information, price, etc.), formats the results and transmits the formatted results to the retail mobile purchase software application.
6. Salesperson selects correct item from search and the retail mobile purchase software application receives the selection.
7. The retail mobile purchase software application displays the item number, price, and available quantity are displayed.

Some or all these aspects of the invention may be implemented in hardware or software, or a combination of both (e.g., programmable logic arrays). Unless otherwise specified, the algorithms included as part of the invention are not inherently related to any particular computer or other apparatus. In particular, various general purpose machines may be used with programs written in accordance with the teachings herein, or it may be more convenient to construct more specialized apparatus (e.g., integrated circuits) to perform particular functions. Thus, the invention may be implemented in one or more computer programs executing on one or more programmable computer systems each comprising at least one processor, at least one data storage system (which may include volatile and non-volatile memory and/or storage elements), at least one input device or port, and at least one output device or port. Program code is applied to input data to perform the functions described herein and generate output information. The output information is applied to one or more output devices, in known fashion.

Each such program may be implemented in any desired computer language (including machine, assembly, or high level procedural, logical, or object oriented programming languages) to communicate with a computer system. In any case, the language may be a compiled or interpreted language.

Each such computer program is preferably stored on or downloaded to a storage media or device (e.g., solid state memory or media, or magnetic or optical media) readable by a general or special purpose programmable computer, for configuring and operating the computer when the storage media or device is read by the computer system to perform the procedures described herein. The inventive system may also be considered to be implemented as a computer-readable storage medium, configured with a computer program, where the storage medium so configured causes a computer system to operate in a specific and predefined manner to perform the functions described herein.

1-10. (canceled)

11. A computer-implemented method for a computing device operating in a retail environment, the computing device including a memory, a processor, the memory storing instructions which when executed by the processor, cause the computing device to:
receive a transaction request that was transmitted wirelessly from a portable electronic device running a retail mobile software application, the transaction request being sent to an external retail purchase server device;
retrieve configuration settings for the external retail purchase server device;
format the transaction request according to the retrieved configuration settings; and
transmit the formatted transaction request to the external retail purchaser server device.

12. The computer-implemented method for claim 11, further includes instructions which when executed by the processor, causing the computing device to:
receive a response to the transaction request from the external retail purchaser server device;
retrieve configuration settings for the portable electronic device that transmitted the transaction request;
format the response according to retrieved configuration settings for the portable electronic device that transmitted the transaction request; and
transmit the formatted response to the portable electronic device that transmitted the transaction request.

13. The computer-implemented method for claim 11, wherein one of the configuration settings is a database engine utilized by the external retail purchaser server device and the formatted request is written utilizing the database engine's query language.

14. The computer-implemented method for claim 11, wherein one of the configuration settings is a communication protocol utilized to communicate with the external retail purchaser server device and the formatted request is communicated via the retrieved communication protocol.

15. A computing device, comprising:
a central dispatch module to receive a transaction request from a portable electronic device and to transfer the transaction request;
a communications module to receive the transferred transaction request and to transfer the transferred request;
a translation module to receive the transferred request, to identify a retail purchase server to which the portable electronic device is connected and request configuration settings for the retail purchase server; and
a configuration module to retrieve the configuration settings for the retail purchase server and to transmit the retail purchase server configuration settings to the translation module, wherein the translation module utilizes the configuration settings for the retail purchase server to format the transferred transaction request to create the formatted transaction request.

16. The computing device of claim 15, further includes a connections module, wherein the translation module transmits the formatted transaction request to the connections module, which transmits the formatted transaction request to the retail purchase server.

17. The computing device of claim 16, wherein the connection module receives a response to the transaction request from the external retail purchaser server device and transfers the received response to the translation module; and
the translation module receives the received response, retrieves configuration settings for the portable electronic device that transmitted the transaction request, formats the received response according to retrieved configuration settings for the portable electronic device that transmitted the transaction request; and transfers the formatted response to the communications module, which transfers the format response to the portable electronic device utilizing the central dispatch service module.

18. The computing device of claim 15, wherein one of the configuration settings is a database engine utilized by the external retail purchaser server device and the formatted request is written utilizing the database engine's query language.

19. The computing device of claim 15, wherein one of the configuration settings is a communication protocol utilized to communicate with the external retail purchase server device and the formatted request is communicated via the retrieved communication protocol.
